(19) United States
(12) Patent Application Publication
(10) Pub. No.: US 2024/0300380 A1
(43) Pub. Date: Sep. 12, 2024

(54) IN-VEHICLE SWITCHING DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yusuke ISAJI, Osaka-shi, Osaka (JP); Takayoshi BANDO, Osaka-shi, Osaka (JP)

(21) Appl. No.: 18/557,614

(22) PCT Filed: Apr. 8, 2022
(86) PCT No.: PCT/JP2022/017316

§ 371 Date: May 28, 2024

(30) Foreign Application Priority Data
Apr. 29, 2021 (JP) 2021-076930

(51) Int. Cl. B60L 58/19; H02J 7/00

(52) U.S. Cl. CPC B60L 58/19; H02J 7/0024; H02J 7/00304; B60L 2240/549

(57) ABSTRACT

Provided is an in-vehicle switching device including a switching circuit; a first conduction path through which a current is allowed to flow in the series connection state and a current does not flow in the parallel connection state; a second conduction path through which a current is allowed to flow in the parallel connection state and a current does not flow in the series connection state; a third conduction path that forms a path between a negative electrode of a first battery and a positive electrode of a second battery in the series connection state, and forms a path between both positive electrodes or between both negative electrodes of the first battery and the second battery in the parallel connection state; and a fuse portion that is provided in the first conduction path and performs an operation of interrupting the first conduction path based on an external signal.

### CROSS-REFERENCE TO RELATED APPLICATIONS

This application is the U.S. national stage of PCT/JP2022/017316 filed on Apr. 8, 2022, which claims priority of Japanese Patent Application No. JP 2021-076930 filed on Apr. 29, 2021, the contents of which are incorporated herein.

### TECHNICAL FIELD

The present disclosure relates to an in-vehicle switching device.

### BACKGROUND

The vehicle power supply device disclosed in JP 2007-274830 A is a device that can connect a first power storage means and a second power storage means in series or in parallel. In this vehicle power supply device, when the first power storage means and the second power storage means are connected in series to an inverter, a control means turns on a third switch means to energize one charge resistor. The control device turns on a first switch means after the energization, and constitutes a circuit for series connection.

In the vehicle power supply device of JP 2007-274830 A, when a conduction path connecting the first power storage means and the second power storage means in series is short-circuited, there is a concern that the conduction path cannot be interrupted even by an off operation of the first switch means. In the conventional technique, a countermeasure against such a concern has not been taken.

Therefore, an object of the present disclosure is, in an in-vehicle switching device that switches a plurality of batteries between a series connection state and a parallel connection state, to more reliably interrupt a conduction path through which a current is allowed to flow in the series connection state.

### SUMMARY

An in-vehicle switching device for a vehicle according to the present disclosure is an in-vehicle switching device used in an in-vehicle power supply system including a battery unit including at least a first battery and a second battery, and a switching circuit that is switched between a series connection state where the first battery and the second battery are connected in series and a parallel connection state where the first battery and the second battery are connected in parallel, the in-vehicle switching device including the switching circuit; a first conduction path that is a path through which a current is allowed to flow in the series connection state and a current does not flow in the parallel connection state; a second conduction path that is a path through which a current is allowed to flow in the parallel connection state and a current does not flow in the series connection state; a third conduction path that forms a path between a negative electrode of the first battery and a positive electrode of the second battery in the series connection state, and forms a path between both positive electrodes or between both negative electrodes of the first battery and the second battery in the parallel connection state; and a fuse portion that is provided in the first conduction path and performs an operation of interrupting the first conduction path based on an external signal.

### Advantageous Effects

An object of an in-vehicle switching device according to the present disclosure is, in a configuration in which a plurality of batteries is switched between the series connection state and the parallel connection state, to forcibly interrupt a conduction path through which a current is allowed to flow in a series connection state.

### BRIEF DESCRIPTION OF DRAWINGS

FIG. 1 is a schematic diagram conceptually illustrating an in-vehicle power supply system including an in-vehicle switching device according to a first embodiment.

FIG. 2 is a schematic diagram illustrating a state in which a series switch is inadvertently brought into an on state in a parallel connection state in the in-vehicle power supply system of FIG. 1.

FIG. 3 is a schematic diagram illustrating a state in which a power feed path is short-circuited in a parallel connection state in the in-vehicle power supply system of FIG. 1.

FIG. 4 is a schematic diagram illustrating a state in which a second parallel switch is brought into an on state in a series connection state in the in-vehicle power supply system of FIG. 1.

FIG. 5 is a schematic diagram illustrating a state in which power is supplied from a battery unit to a load in a parallel connection state in the in-vehicle power supply system of FIG. 1.

### DETAILED DESCRIPTION OF PREFERRED EMBODIMENTS

Hereinafter, an embodiment of the present disclosure will be listed and exemplified. Note that the features of [1] to [6] described below may be combined in any manner without contradiction.

In a first aspect, an in-vehicle switching device of the present disclosure is used in an in-vehicle power supply system including a battery unit including at least a first battery and a second battery, and a switching circuit that is switched between a series connection state where the first battery and the second battery are connected in series and a parallel connection state where the first battery and the second battery are connected in parallel. The in-vehicle switching device includes: the switching circuit; a first conduction path that is a path through which a current is allowed to flow in the series connection state and a current does not flow in the parallel connection state; a second conduction path that is a path through which a current is allowed to flow in the parallel connection state and a current does not flow in the series connection state; a third conduction path that forms a path between a negative electrode of the first battery and a positive electrode of the second battery in the series connection state, and forms a path between both positive electrodes or between both negative electrodes of the first battery and the second battery in the parallel connection state; and a fuse portion that is provided in the first conduction path and performs an operation of interrupting the first conduction path based on an external signal.

In the in-vehicle switching device of the first aspect, even when a current flows through the first conduction path due to an inadvertent operation, a short-circuit failure, or the like of the switching circuit in the parallel connection state and the first conduction path cannot be interrupted even by the switching circuit, the fuse portion can be caused to perform an interruption operation based on an external signal. This enables the in-vehicle switching device to more reliably interrupt the first conduction path.

In a second aspect, the in-vehicle switching device of the first aspect may include a current detection unit that detects a current in the third conduction path. The fuse portion may perform an operation of interrupting the first conduction path based on the current detected by the current detection unit.

The in-vehicle switching device described in in the second aspect can detect a current (current between batteries) in the third conduction path by the current detection unit. Therefore, the in-vehicle switching device can interrupt the first conduction path by the fuse portion based on the current generated between the batteries.

In a third aspect, in the in-vehicle switching device of the second aspect, the fuse portion may perform the operation of interrupting the first conduction path based on an interruption signal output by a control unit when the current detected by the current detection unit satisfies a predetermined condition.

The in-vehicle switching device described in the third aspect can interrupt the first conduction path by the fuse portion after determining whether or not the current in the third conduction path satisfies the predetermined condition.

In a fourth aspect, the in-vehicle switching device of any of the first through the third aspects may include a control unit that outputs an interruption signal to the fuse portion when the current in the third conduction path satisfies the predetermined condition. The fuse portion can perform an operation of interrupting the first conduction path when the interruption signal is output from the control unit.

The in-vehicle switching device described in the fourth aspect can interrupt the first conduction path based on determination (determination as to whether or not the current of the third conduction path satisfies the predetermined condition) of the control unit provided in the in-vehicle switching device itself, and therefore the in-vehicle switching device can complete the interruption operation in the device.

In a fifth aspect, in the in-vehicle switching device of any of the first through the fourth aspects, the in-vehicle power supply system may include a power path that is a path for transmitting power from the battery unit both in the series connection state and in the parallel connection state. The in-vehicle switching device may include an external fuse portion provided in the power path and having a function of interrupting energization of the power path.

The in-vehicle switching device described in the fifth aspect can interrupt energization of the power path by the external fuse portion to protect the device even when a ground fault, a short circuit, or the like occurs in the power path or the like in the parallel connection state.

In a sixth aspect, in the in-vehicle switching device of the fifth aspect, the external fuse portion may perform an operation of interrupting energization of the power path based on an external signal.

The in-vehicle switching device described in in the sixth aspect can forcibly cause the fuse portion provided in the power path to perform an interruption operation based on an external signal. Therefore, the in-vehicle switching device easily interrupts energization of the power path as compared with a configuration provided with a thermal fuse or the like that performs the interruption operation when the interruption characteristic (rated current) is satisfied.

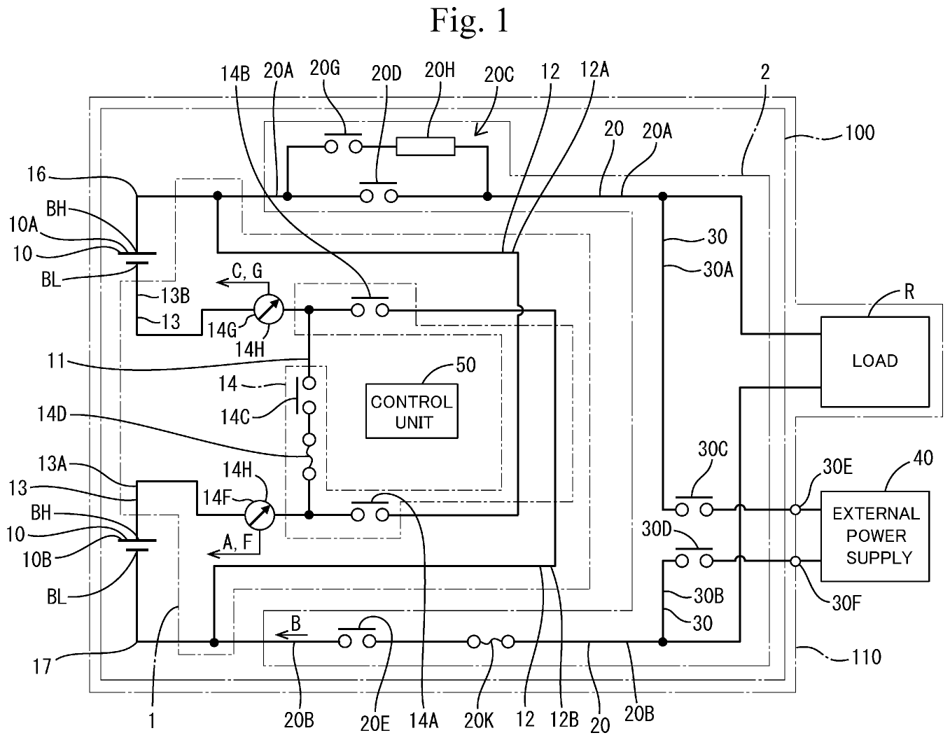

FIG. 1 exemplifies an in-vehicle power supply system 100 provided with an in-vehicle switching device 1 according to the first embodiment. A vehicle 110 includes the in-vehicle power supply system 100 and a load R (e.g., a motor for driving wheels, or the like). The in-vehicle power supply system 100 is used as a power supply for operating the load R of the vehicle on which the in-vehicle power supply system 100 is mounted. The in-vehicle power supply system 100 includes a battery unit 10, a high potential side conduction path 16, a low potential side conduction path 17, the in-vehicle switching device 1, a power path 20, a junction box unit 2, and a power feed path 30. The battery unit 10 includes a first battery 10A and a second battery 10B. The in-vehicle switching device 1 includes a first conduction path 11, a second conduction path 12, a third conduction path 13, a switching circuit 14, a current detection unit 14H, and a control unit 50. The in-vehicle switching device 1 is used for the in-vehicle power supply system 100.

The first battery 10A and the second battery 10B in the battery unit 10 include a plurality of cell units configured as unit cells, and have a configuration where the cell units are integrally combined. The cell units are not illustrated. In each of the first battery 10A and the second battery 10B, the highest potential electrode of the plurality of unit cells electrically connected in series is a positive electrode BH, and the lowest potential electrode of the plurality of unit cells electrically connected in series is a negative electrode BL.

In the present disclosure, “electrically connected” is desirably a configuration where both connection targets are connected in a state of being conductive to each other (state where current can flow) such that potentials of both the connection targets become equal. However, the present disclosure is not limited to this configuration. For example, “electrically connected” may be a configuration where both connection targets are connected in a state where both the connection targets are conductible while an electric component is interposed between both the connection targets.

One end of the high potential side conduction path 16 is electrically connected to the positive electrode BH of the first battery 10A. One end of the low potential side conduction path 17 is electrically connected to the negative electrode BL of the second battery 10B.

The second conduction path 12 allows a current to flow therethrough in a parallel connection state in which the first battery 10A and the second battery 10B are electrically connected in parallel (hereinafter, simply referred to as parallel connection state). The second conduction path 12 is a path through which no current flows in a series connection state where the first battery 10A and the second battery 10B are electrically connected in series (hereinafter, simply referred to as series connection state). The second conduction path 12 includes an inter-positive electrode conduction path 12A and an inter-negative electrode conduction path 12B. One end of the inter-positive electrode conduction path 12A is electrically connected to the other end of the high potential side conduction path 16. One end of the inter-negative electrode conduction path 12B is electrically connected to the other end of the low potential side conduction path 17. The inter-positive electrode conduction path 12A is a path through which a current flows between the positive electrode BH of the second battery 10B and the positive electrode BH of the first battery 10A in the parallel connection state, and is a path through which a current flows between the positive electrode BH of the second battery 10B and the positive electrode BH of the first battery 10A in the series connection state. The inter-negative electrode conduction path 12B is a path through which a current flows between the negative electrode BL of the second battery 10B and the negative electrode BL of the first battery 10A in the parallel connection state, and is a path through which a current flows between the negative electrode BL of the second battery 10B and the negative electrode BL of the first battery 10A in the series connection state.

The third conduction path 13 forms a path between the negative electrode BL of the first battery 10A and the positive electrode BH of the second battery 10B in the series connection state, and forms a path between both the positive electrodes BH or between both the negative electrodes BL of the first battery 10A and the second battery 10B in the parallel connection state. The third conduction path 13 includes a first common path 13A and a second common path 13B. One end of the first common path 13A is electrically connected to the positive electrode BH of the second battery 10B. The other end of the first common path 13A is electrically connected to the other end of the inter-positive electrode conduction path 12A. One end of the second common path 13B is electrically connected to the negative electrode BL of the first battery 10A. The other end of the second common path 13B is electrically connected to the other end of the inter-negative electrode conduction path 12B.

The high potential side conduction path 16, the inter-positive electrode conduction path 12A, and the first common path 13A form a path for conducting electricity between both the positive electrodes BH of the first battery 10A and the second battery 10B in the parallel connection state. That is, the first common path 13A is a conduction path for conducting electricity between both the positive electrodes BH of the first battery 10A and the second battery 10B in the parallel connection state. The low potential side conduction path 17, the inter-negative electrode conduction path 12B, and the second common path 13B form a path for conducting electricity between both the negative electrodes BL of the first battery 10A and the second battery 10B in the parallel connection state. That is, the second common path 13B is a conduction path for conducting electricity between both the negative electrodes BL of the first battery 10A and the second battery 10B in the parallel connection state.

The first conduction path 11 is a path where a current is allowed to flow in the series connection state and a current does not flow in the parallel connection state. One end of the first conduction path 11 is electrically connected to the other end of the second common path 13B and the other end of the inter-negative electrode conduction path 12B. The other end of the first conduction path 11 is electrically connected to the other end of the first common path 13A and the other end of the inter-positive electrode conduction path 12A. That is, the first conduction path 11 is electrically connected in series to the first battery 10A and the second battery 10B via the first common path 13A and the second common path 13B. The first conduction path 11 is a path through which no current flows between the positive electrode BH of the second battery 10B and the negative electrode BL of the first battery 10A in the parallel connection state.

The switching circuit 14 has a function of switching between the series connection state where the first battery 10A and the second battery 10B are connected in series and the parallel connection state where they are connected in parallel. The switching circuit 14 includes a first parallel switch 14A, a second parallel switch 14B, a series switch 14C, and a fuse portion 14D.

The first parallel switch 14A, the second parallel switch 14B, and the series switch 14C are constituted by, for example, relay switches or semiconductor switches such as MOSFETs. The first parallel switch 14A is provided to be interposed in the inter-positive electrode conduction path 12A. The second parallel switch 14B is provided to be interposed in the inter-negative electrode conduction path 12B. The series switch 14C is provided to be interposed in the first conduction path 11. The first parallel switch 14A, the second parallel switch 14B, and the series switch 14C are configured to be switchable between an on state and an off state by the control unit 50, for example, which will be described later.

The fuse portion 14D is provided to be interposed in the first conduction path 11 so as to be in series with the series switch 14C. In the first conduction path 11, the fuse portion 14D is located on the other end side relative to the series switch 14C. The fuse portion 14D performs an operation of interrupting the first conduction path 11 based on an external signal (e.g., an interruption signal output from the control unit 50). The fuse portion 14D is configured as, for example, a pyrofuse or a semiconductor switch. A pyrofuse ignites gunpowder based on an external signal, for example, and instantaneously generates an explosive force to rupture the first conduction path 11. The semiconductor switch is constituted by, for example, a MOSFET, a GaNFET, a bipolar transistor, and an IGBT, permits energization of the first conduction path 11 by an on operation based on an external signal, and interrupts the first conduction path 11 by an off operation based on an external signal.

The control unit 50 is configured as, for example, an information processing device having a calculation function and an information processing function. The control unit 50 may be configured as a microcomputer, or may be configured as an information processing device other than this. The control unit 50 switches the first parallel switch 14A, the second parallel switch 14B, and the series switch 14C to the on state or the off state by a control signal. The control unit 50 outputs an interruption signal to the fuse portion 14D when the current of the third conduction path 13 (current detected by the current detection unit 14H described later) satisfies a predetermined condition. The case where the predetermined condition is satisfied is, for example, a case where the interruption characteristic of the fuse portion 14D set in advance by the control unit 50 is satisfied. The interruption characteristic defines, for example, how much current value and how long the current is to flow continuously for interrupting a path. The control unit 50 determines that the predetermined condition is satisfied when the current value of the current detected by the current detection unit 14H described later becomes a predetermined current value and the current having such current value flows for a predetermined time.

The current detection unit 14H includes a first detection unit 14F and a second detection unit 14G. The first detection unit 14F is provided to be interposed in the first common path 13A. The second detection unit 14G is provided to be interposed in the second common path 13B. The first detection unit 14F and the second detection unit 14G include, for example, a resistor and a differential amplifier, and are configured to be capable of outputting, as a current value, a value indicating a current flowing through each of the first common path 13A and the second common path 13B (specifically, an analog voltage according to the value of the current flowing through each of the first common path 13A and the second common path 13B). The first detection unit 14F detects the state of the current flowing through the first common path 13A, and the second detection unit 14G detects the state of the current flowing through the second common path 13B. The current values output from the first detection unit 14F and the second detection unit 14G can be input to the control unit 50, for example. That is, the current detection unit 14H detects the current flowing through the first common path 13A (third conduction path 13) and the second common path 13B (third conduction path 13).

The junction box unit 2 has a function of being able to supply power from the battery unit 10 to the load R or the like. The junction box unit 2 includes a high potential side power path 20A serving as the power path 20, a low potential side power path 20B serving as the power path 20, a high potential side switch 20D, a bypass section 20C, a low potential side switch 20E, an external fuse portion 20K, a high potential side power feed path 30A serving as the power feed path 30, a low potential side power feed path 30B serving as the power feed path 30, a first power feed switch 30C, and a second power feed switch 30D.

The power path 20 is a path for transmitting power from the battery unit 10, both in the series connection state and in the parallel connection state. One end of the high potential side power path 20A is electrically connected to the other end of the high potential side conduction path 16 and one end of the inter-positive electrode conduction path 12A. One end of the low potential side power path 20B is electrically connected to the other end of the low potential side conduction path 17 and one end of the inter-negative electrode conduction path 12B.

The high potential side switch 20D is provided to be interposed in the high potential side power path 20A. The bypass section 20C is provided to be electrically connected in parallel to the high potential side switch 20D. The bypass section 20C includes a bypass switch 20G and a resistor 20H. The bypass switch 20G and the resistor 20H are electrically connected in series. The bypass switch 20G is interposed between the resistor 20H and the high potential side conduction path 16.

The low potential side switch 20E is provided to be interposed in the low potential side power path 20B. The high potential side switch 20D, the bypass switch 20G, and the low potential side switch 20E are constituted by, for example, relay switches or semiconductor switches such as MOS FETs.

The external fuse portion 20K is provided in the power path 20 and has a function of interrupting energization of the power path 20. The external fuse portion 20K is provided to be interposed in the low potential side power path 20B on the opposite side of the low potential side conduction path 17 across the low potential side switch 20E. The external fuse portion 20K performs an operation of interrupting energization of the power path 20 based on an external signal. The external fuse portion 20K is configured as, for example, a pyrofuse or a semiconductor switch. A pyrofuse ignites gunpowder based on an external signal, for example, and instantaneously generates an explosive force to rupture the power path 20. The semiconductor switch is constituted by, for example, a MOSFET, a GaNFET, a bipolar transistor, and an IGBT, permits energization of the power path 20 by an on operation based on an external signal, and interrupts the power path 20 by an off operation based on an external signal. The load R is electrically connected between the other end side of the high potential side power path 20A and the other end side of the low potential side power path 20B.

The power feed path 30 is electrically connected to the power path 20. One end of the high potential side power feed path 30A serving as the power feed path 30 is electrically connected between the bypass section 20C and the load R in the high potential side power path 20A. One end of the low potential side power feed path 30B serving as the power feed path 30 is electrically connected between the external fuse portion 20K and the load R in the low potential side power path 20B. The other end side of the high potential side power feed path 30A and the other end side of the low potential side power feed path 30B are provided with terminals 30E and 30F, respectively. An external power supply 40 can be electrically connected to the terminals 30E and 30F. The external power supply 40 supplies power to the power path 20. The first power feed switch 30C is provided to be interposed in the high potential side power feed path 30A. The second power feed switch 30D is provided to be interposed in the low potential side power feed path 30B.

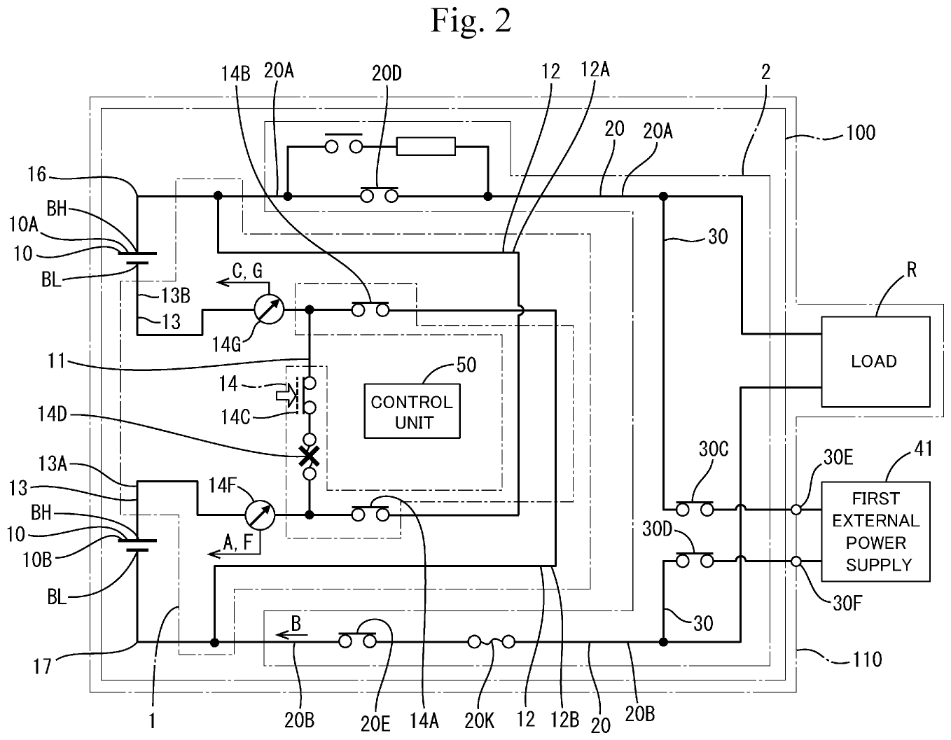

A case of a parallel connection state in which the first battery 10A and the second battery 10B of the battery unit 10 are electrically connected in parallel at the time of charging will be described. In this case, a first external power supply 41 is connected to the terminals 30E and 30F, and by using a first charging method, a first voltage (e.g., 400 V) is applied to the battery unit 10, a first current (e.g., 400 A) is applied to the battery unit 10, and a first power (e.g., 150 kW) is supplied. For example, as illustrated in FIG. 2, the control unit 50 switches the first parallel switch 14A and the second parallel switch 14B to the on state and switches the series switch 14C to the off state. This brings the first battery 10A and the second battery 10B into a state of being electrically connected in parallel. Thus, the switching circuit 14 is brought into the parallel connection state. Thereafter, the high potential side switch 20D and the low potential side switch 20E are switched to the on state, and the first power feed switch 30C and the second power feed switch 30D are switched to the on state, so that power is supplied from the first external power supply 41 to the battery unit 10. At this time, the high potential side conduction path 16, the inter-positive electrode conduction path 12A, and the first common path 13A form a path for conducting electricity between both the positive electrodes BH of the first battery 10A and the second battery 10B. Together with this, the low potential side conduction path 17, the inter-negative electrode conduction path 12B, and the second common path 13B form a path for conducting electricity between both the negative electrodes BL of the first battery 10A and the second battery 10B.

At this time, the current flowing through the first common path 13A is detected as a current value A by the first detection unit 14F provided in the first common path 13A. Together with this, the current flowing through the second common path 13B is detected as a current value C by the second detection unit 14G provided in the second common path 13B.

The first detection unit 14F and the second detection unit 14G detect the currents in the first common path 13A and the second common path 13B as the current values A and C, simultaneously, for example. Then, the current values A and C having been detected are input to the control unit 50 simultaneously. In the control unit 50, the current value A and the current value C are added. A current value B, which is a calculation result of this addition, corresponds to the current flowing through the low potential side power path 20B (high potential side power path 20A). The current value B thus obtained is a value at the same time as when the first detection unit 14F and the second detection unit 14G detect the current in the first common path 13A and the second common path 13B. In this way, the control unit 50 can grasp the magnitude of the current flowing through the low potential side power path 20B as the current value B, o the basis of the current values C and A corresponding to the magnitude of the currents flowing through the second common path 13B and the first common path 13A.

The control unit 50 is configured to be able to monitor whether or not the magnitude of the current flowing through the first common path 13A (inter-positive electrode conduction path 12A) and the magnitude of the current flowing through the second common path 13B (inter-negative electrode conduction path 12B) have reached a predetermined threshold. For example, in a case where the series switch 14C is inadvertently switched to the on state or short-circuited, and thus the first conduction path 11 cannot be interrupted even by the switching circuit 14, the control unit 50 causes the fuse portion 14D to interrupt the energization of the power path 20 when determining that the current of the third conduction path 13 satisfies the predetermined condition (when determining that the magnitude of the current flowing through at least one of the first common path 13A and the second common path 13B has reached the predetermined threshold). The case where the predetermined condition is satisfied is, for example, a case where the interruption characteristic of the fuse portion 14D set in advance by the control unit 50 is satisfied. The interruption characteristic defines, for example, how much current value and how long the current is to flow continuously for interrupting a path. The control unit 50 determines that the predetermined condition is satisfied when the current value of the current detected by the current detection unit 14H (at least one of the first detection unit 14F and the second detection unit 14G) becomes a predetermined current value and the current having such current value flows for a predetermined time.

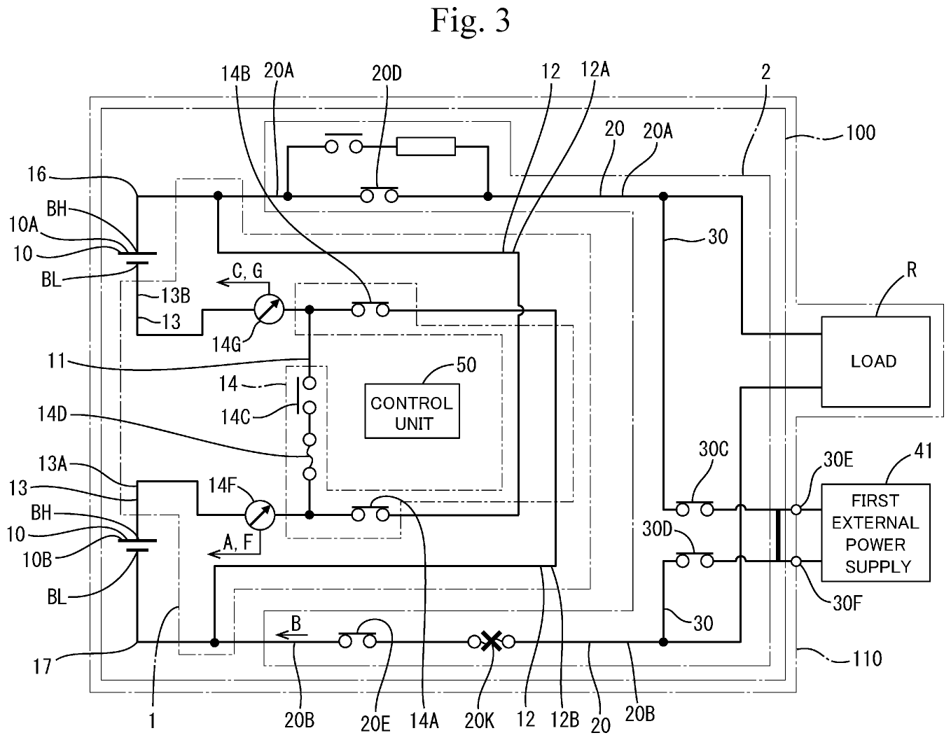

Furthermore, even when a ground fault, a short circuit, or the like occurs in the power path 20, the power feed path 30, or the like in the parallel connection state, the control unit 50 can interrupt energization of the power path 20 by the external fuse portion 20K. When the control unit 50 determines that the current of the third conduction path 13 satisfies the predetermined condition (when the control unit 50 determines that the magnitude of the current flowing through at least one of the first common path 13A and the second common path 13B has reached the predetermined threshold), the control unit 50 causes the external fuse portion 20K to interrupt the energization of the power path 20. For example, as illustrated in FIG. 3, when a short circuit occurs in the power feed path 30, the control unit 50 causes the external fuse portion 20K to interrupt the energization of the power path 20. The case where the predetermined condition is satisfied is, for example, a case where the interruption characteristic of the external fuse portion 20K set in advance by the control unit 50 is satisfied. The interruption characteristic defines, for example, how much current value and how long the current is to flow continuously for interrupting a path. The control unit 50 determines that the predetermined condition is satisfied when the current value of the current detected by the current detection unit 14H (at least one of the first detection unit 14F and the second detection unit 14G) becomes a predetermined current value and the current having such current value flows for a predetermined time.

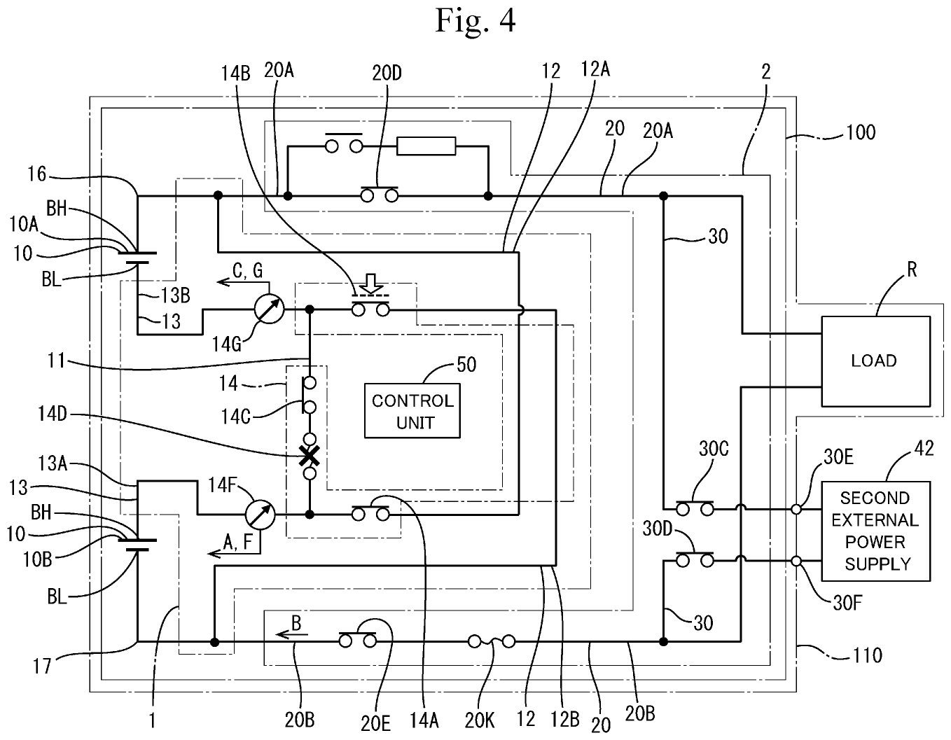

A case of a series connection state in which the first battery 10A and the second battery 10B of the battery unit 10 are electrically connected in series at the time of charging will be described. In this case, a second external power supply 42 is connected to the terminals 30E and 30F, and by using a second charging method, a second voltage (e.g., 800 V) larger than the first voltage is applied to the battery unit 10, a second current (e.g., 400 A) is applied to the battery unit 10, and a second power (e.g., 350 KW) is supplied. For example, as illustrated in FIG. 4, the control unit 50 switches the first parallel switch 14A and the second parallel switch 14B to the off state and switches the series switch 14C to the on state. This brings the first battery 10A and the second battery 10B into a state of being electrically connected in series. Thus, the switching circuit 14 is brought into the series connection state. Thereafter, the high potential side switch 20D and the low potential side switch 20E are switched to the on state, and the first power feed switch 30C and the second power feed switch 30D are switched to the on state, so that power is supplied from the second external power supply 42 to the battery unit 10.

At this time, the current flowing through the first common path 13A is detected as a current value F by the first detection unit 14F provided in the first common path 13A, and the current flowing through the second common path 13B is detected as a current value G by the second detection unit 14G provided in the second common path 13B. The first detection unit 14F and the second detection unit 14G detect the currents in the first common path 13A and the second common path 13B simultaneously, for example. Then, the current values F and G are input to the control unit 50 simultaneously. The first battery 10A and the second battery 10B are electrically connected in series. Therefore, the current values F and G are the same value. The current flowing through the low potential side power path 20B (high potential side power path 20A) also has the same value as the current value F (current value G). Thus, the control unit 50 can grasp, as the current values F and G, the magnitude of the current generated from the battery unit 10.

The control unit 50 is configured to be able to monitor whether or not the magnitude of the current flowing through the third conduction path 13 (first conduction path 11) have reached a predetermined threshold. For example, as shown in FIG. 4, in a case where the second parallel switch 14B is inadvertently switched to the on state or the like and thus the first conduction path 11 cannot be interrupted even by the switching circuit 14, the control unit 50 causes the fuse portion 14D to interrupt the energization of the power path 20 when determining that the current of the third conduction path 13 satisfies the predetermined condition (when determining that the magnitude of the current flowing through the first common path 13A has reached the predetermined threshold). The case where the predetermined condition is satisfied is, for example, a case where the interruption characteristic of the fuse portion 14D set in advance by the control unit 50 is satisfied. The interruption characteristic defines, for example, how much current value and how long the current is to flow continuously for interrupting a path. The control unit 50 determines that the predetermined condition is satisfied when the current value of the current detected by the current detection unit 14H (at least one of the first detection unit 14F and the second detection unit 14G) becomes a predetermined current value and the current having such current value flows for a predetermined time.

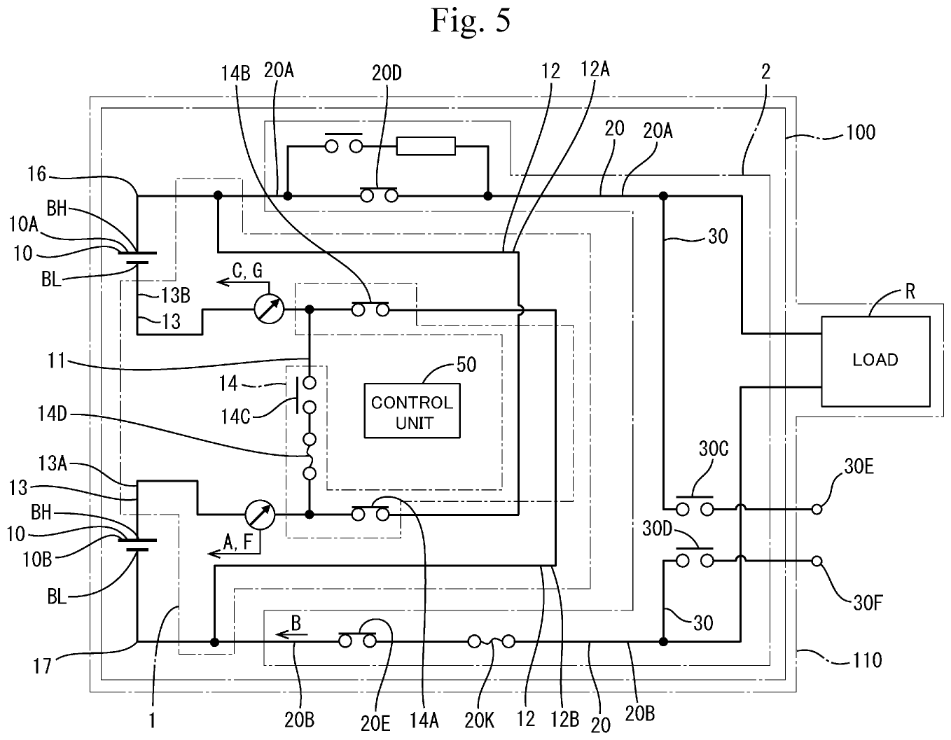

A case where the load R operates will be described. At the time of operation of the load R, the first battery 10A and the second battery 10B of the battery unit 10 are electrically connected in parallel, for example. In this case, as illustrated in FIG. 5, for example, control unit 50 switches the first parallel switch 14A and the second parallel switch 14B to the on state and switches the series switch 14C to the off state. This brings the first battery 10A and the second battery 10B into a state of being electrically connected in parallel. Thus, the switching circuit 14 is brought into the parallel connection state. Thereafter, the high potential side switch 20D and the low potential side switch 20E are switched to the on state, and the first power feed switch 30C and the second power feed switch 30D are switched to the off state, so that power is supplied from the battery unit 10 to the load R. At this time, the high potential side conduction path 16, the inter-positive electrode conduction path 12A, and the first common path 13A form a path for conducting electricity between both the positive electrodes BH of the first battery 10A and the second battery 10B. Together with this, the low potential side conduction path 17, the inter-negative electrode conduction path 12B, and the second common path 13B form a path for conducting electricity between both the negative electrodes BL of the first battery 10A and the second battery 10B.

Next, effects of the configuration according to the present disclosure will be exemplified.

The in-vehicle switching device 1 of the present disclosure can cause the fuse portion 14D to perform an interruption operation based on an external signal even when a current flows through the first conduction path 11 due to an inadvertent operation, a short-circuit failure, or the like of the switching circuit 14 in the parallel connection state and the first conduction path 11 cannot be interrupted even by switching circuit 14. This enables the in-vehicle switching device 1 to more reliably interrupt the first conduction path 11.

In the in-vehicle switching device 1 of the present disclosure, the current detection unit 14H can detect the current (current between the batteries) in the third conduction path 13. Therefore, the in-vehicle switching device 1 can interrupt the first conduction path 11 by the fuse portion 14D based on the current generated between the batteries.

In the in-vehicle switching device 1 of the present disclosure, the fuse portion 14D performs the operation of interrupting the first conduction path 11 based on the interruption signal output from the control unit 50 when the current detected by current detection unit 14H satisfies the predetermined condition. The in-vehicle switching device 1 can interrupt the first conduction path 11 by the fuse portion 14D after determining whether or not the current of the third conduction path 13 satisfies the predetermined condition.

The in-vehicle switching device 1 of the present disclosure includes the control unit 50 which outputs the interruption signal to the fuse portion 14D when the current in the third conduction path 13 satisfies the predetermined condition. The fuse portion 14D performs the operation of interrupting the first conduction path 11 when the interruption signal is output from the control unit 50. As a result, the in-vehicle switching device 1 can interrupt the first conduction path 11 based on determination (determination as to whether or not the current of the third conduction path 13 satisfies the predetermined condition) of the control unit 50 provided in the in-vehicle switching device 1 itself, and therefore the in-vehicle switching device 1 can complete the interruption operation in the device.

The in-vehicle power supply system 100 of the present disclosure includes the power path 20 which is a path for transmitting power from the battery unit 10 both in the series connection state and in the parallel connection state. The in-vehicle switching device 1 includes the external fuse portion 20K provided in the power path 20 and having a function of interrupting energization of the power path 20. Due to this, the in-vehicle switching device 1 can interrupt energization of the power path 20 by the external fuse portion 20K to protect the device even when a ground fault, a short circuit, or the like occurs in the power path 20 or the like in the parallel connection state.

In the in-vehicle switching device 1 of the present disclosure, the external fuse portion 20K performs an operation of interrupting energization of power path 20 based on an external signal. Due to this, the in-vehicle switching device 1 can forcibly cause the fuse portion 14D provided in the power path 20 to perform the interruption operation based on an external signal. Therefore, the in-vehicle switching device 1 easily interrupts energization of the power path 20 as compared with a configuration provided with a thermal fuse or the like that performs the interruption operation when the interruption characteristic (rated current) is satisfied.

The present disclosure is not limited to the embodiment described with reference to the above description and drawings. For example, the features of the embodiments described above or below can be combined in any manner within a range not contradictory. Any of the features of the embodiments described above or below can be omitted unless clearly indicated as being essential. Furthermore, the embodiment described above may be modified as follows.

In the first embodiment, an example in which the external fuse portion 20K is configured to interrupt energization of the power path 20 based on an external signal (pyrofuse, semiconductor switch) has been described, but the external fuse portion may be configured by, for example, a thermal fuse or the like. The external fuse portion 20K is fused according to its own interruption characteristic (e.g., rated current) and interrupts energization in the low potential side power path 20B.

In the first embodiment, a case where the interruption characteristic of the fuse portion 14D set in advance is satisfied has been exemplified as a case where the predetermined condition (condition for outputting an interruption signal for the fuse portion 14D) is satisfied, but other configurations may be adopted. For example, the case where the predetermined condition is satisfied may be a case where the current value of the current of the third conduction path 13 (current detected by the current detection unit 14H described later) reaches a predetermined threshold. Alternatively, the case where the predetermined condition is satisfied may be a case where the temperature detected by a temperature detection unit provided in the in-vehicle power supply system 100 (e.g., temperature of the battery unit 10 or the like) reaches a predetermined temperature (threshold).

In the first embodiment, the control unit 50 is provided in the in-vehicle switching device 1, but may be provided in the in-vehicle power supply system or may be provided outside the in-vehicle power supply system.

In the first embodiment, an example in which the load R operates when the battery unit 10 is in the parallel connection state has been described, but the load R may operate when the battery unit 10 is in the series connection state, or the series connection state and the parallel connection state of the battery unit 10 may be switched when the load R operates.

In the first embodiment, a configuration where when the magnitude of the current flowing through at least one of first common path 13A and second common path 13B reaches the predetermined threshold in the parallel connection state of battery unit 10, the fuse portion 14D is caused to interrupt energization of power path 20 has been exemplified, but the fuse portion 14D may be configured to interrupt the energization of the power path 20 when the magnitude of the currents flowing through both the first common path 13A and the second common path 13B reach the predetermined threshold.

In the first embodiment, the switching circuit switches the first battery 10A and the second battery 10B between the series connection state and the parallel connection state, but the present disclosure is not limited to this, and the switching circuit may switch three or more batteries between the series connection state and the parallel connection state.

In the first embodiment, the current detection unit is configured to output a current value corresponding to the magnitude of the current flowing through the conduction path. However, the present disclosure is not limited to this, but the current detection unit may include a comparator. In this case, the current detection unit determines whether or not the current value has exceeded a threshold, and when the current value has exceeded the threshold, the current detection unit outputs a threshold excess signal indicating that the current has exceeded the threshold.

It should be understood that the embodiments disclosed herein are illustrative in all respects and are not restrictive. The scope of the present disclosure is not limited to the embodiments disclosed herein, and is intended to include all modifications within the scope indicated by the claims or within the scope equivalent to the claims.

1. An in-vehicle switching device used in an in-vehicle power supply system including a battery unit including at least a first battery and a second battery, and a switching circuit that is switched between a series connection state where the first battery and the second battery are connected in series and a parallel connection state where the first battery and the second battery are connected in parallel, the in-vehicle switching device comprising:
the switching circuit;
a first conduction path that is a path through which a current is allowed to flow in the series connection state and a current does not flow in the parallel connection state;
a second conduction path that is a path through which a current is allowed to flow in the parallel connection state and a current does not flow in the series connection state;
a third conduction path that forms a path between a negative electrode of the first battery and a positive electrode of the second battery in the series connection state, and forms a path between both positive electrodes or between both negative electrodes of the first battery and the second battery in the parallel connection state;
a fuse portion that is provided in the first conduction path and performs an operation of interrupting the first conduction path based on an external signal; and
a current detection unit that detects a current in the third conduction path,
wherein
the fuse portion performs an operation of interrupting the first conduction path based on a current detected by the current detection unit,
the in-vehicle power supply system includes a power path that is a path for transmitting power from the battery unit in both the series connection state and the parallel connection state,
the in-vehicle switching device includes an external fuse portion provided in the power path and having a function of interrupting energization of the power path, and
the external fuse portion performs an operation of interrupting energization of the power path based on a current detected by the current detection unit.

2. (canceled)

3. The in-vehicle switching device according to claim 1, wherein the fuse portion performs an operation of interrupting the first conduction path based on an interruption signal output by a control unit when a current detected by the current detection unit satisfies a predetermined condition.

4. The in-vehicle switching device according to claim 1, including:
a control unit that outputs an interruption signal to the fuse portion when a current in the third conduction path satisfies a predetermined condition, wherein
the fuse portion performs an operation of interrupting the first conduction path when the interruption signal is output from the control unit.

5. (canceled)

6. (canceled)

7. The in-vehicle switching device according to claim 3, including;
a control unit that outputs an interruption signal to the fuse portion when a current in the third conduction path satisfies a predetermined condition, wherein
the fuse portion performs an operation of interrupting the first conduction path when the interruption signal is output from the control unit.
